(19) United States
(12) Patent Application Publication
(10) Pub. No.: US 2015/0009397 A1
(43) Pub. Date: Jan. 8, 2015

(54) IMAGING APPARATUS AND METHOD OF DRIVING THE SAME

(71) Applicant: PANASONIC CORPORATION, Osaka (JP)

(72) Inventors: Takahiro YAMAMOTO, Osaka (JP); Yoshiyuki MATSUNAGA, Kyoto (JP); Takayuki OTA, Kyoto (JP)

(21) Appl. No.: 14/495,365

(22) Filed: Sep. 24, 2014

Related U.S. Application Data
(63) Continuation of application No. PCT/JP2013/007005, filed on Nov. 28, 2013.

(30) Foreign Application Priority Data
Dec. 27, 2012 (JP) 2012-284370

(51) Int. Cl. H04N 5/235; H04N 5/335; H04N 5/232

(52) U.S. Cl. CPC H04N 5/2353; H04N 5/23245; H04N 5/2358; H04N 5/335
USPC 348/367

(57) ABSTRACT

An imaging apparatus disclosed herein includes: a solid-state imaging device in which pixels are arranged in a matrix; a mechanical shutter; and a signal processing unit, wherein the signal processing unit: resets charge stored in all the pixels by closing the mechanical shutter and applying a voltage V2 to a photoelectric conversion unit; starts first exposure by opening the mechanical shutter and applying a voltage V1 to the photoelectric conversion unit; finishes the first exposure by applying the voltage V2 to the photoelectric conversion unit with the mechanical shutter open;

reads pixel signals to obtain a first still image; resets all the pixels; starts second exposure by applying the voltage V1 to the photoelectric conversion unit with the mechanical shutter open; finishes the second exposure by applying the voltage V2 to the photoelectric conversion unit with the mechanical shutter open; reads pixel signals to obtain a second still image.

### CROSS REFERENCE TO RELATED APPLICATIONS

This is a continuation application of PCT International Application No. PCT/JP2013/007005 filed on Nov. 28, 2013, designating the United States of America, which is based on and claims priority of Japanese Patent Application No. 2012-284370 filed on Dec. 27, 2012. The entire disclosures of the above-identified applications, including the specifications, drawings and claims are incorporated herein by reference in their entirety.

### FIELD

One or more exemplary embodiments disclosed herein relate generally to an imaging apparatus and a method of driving the same.

### BACKGROUND

When a still image is captured using a digital camera with a solid-state imaging device such as an image sensor, a mechanical shutter is required to adjust the amount of exposure. An exposure period is a period of time from when all of the pixels in a pixel unit of the solid-state imaging device are reset to when the mechanical shutter is closed.

FIG. 10 is a cross-sectional diagram of a conventional solid-state imaging device disclosed in Patent Literature 1 (Japanese Unexamined Patent Application Publication No. 2009-49525). The solid-state imaging element 900 disclosed in the diagram includes a large number of pixels 902R, 902G, and 902B. Each pixel includes: a photoelectric conversion film 903 formed above a semiconductor substrate 901, absorbing light having a particular wavelength range and generating electric charge according to the absorbed light; a photoelectric conversion element 904 formed inside the semiconductor substrate 901 below the photoelectric conversion film 903. Patent Literature 1 discloses a digital camera including the solid-state imaging element 900 configured as described above. The digital camera includes: an exposure condition determining unit which determines an exposure condition for the photoelectric conversion element 904; and an application voltage adjusting unit which adjusts a voltage to be applied to the photoelectric conversion film 903, to prevent a signal from the photoelectric conversion film 903 included in each pixel from exceeding a saturation level in imaging under the exposure condition. In a state where the voltage adjusted by the application voltage adjusting unit is applied to the photoelectric conversion film 903, imaging based on the exposure condition is performed.

### SUMMARY

### Technical Problem

When a mechanical shutter is combined with the solid-state imaging element disclosed in Patent Literature 1, mechanical shutter operations need to be performed plural times for a one-time imaging operation, which causes a physical time lag. When a moving object is imaged in the state, blurs or distortions of the subject appear in the image, and fast imaging is impossible.

### Solution to Problem

In one general aspect, the techniques disclosed here feature an imaging apparatus including: a solid-state imaging device in which pixels are arranged in a matrix above a substrate, each pixel including (i) a photoelectric conversion unit which performs photoelectric conversion of incident light into signal charge and (ii) a reset unit which resets charge stored in the photoelectric conversion unit; a mechanical shutter for causing all of the pixels to be shielded or exposed at a same time; and a timing control unit configured to control timing for opening and closing the mechanical shutter, applying a voltage to the photoelectric conversion unit, and a reset by the reset unit, wherein the timing control unit is configured to: when a mode for monitoring an image is switched to a mode for capturing a still image, reset the charge stored in all of the pixels by closing the mechanical shutter and applying, to the photoelectric conversion unit, a disabling voltage for disabling movement of the charge generated by the photoelectric conversion unit; and when a plurality of still images are to be captured sequentially: (1) (i) start first exposure by opening the mechanical shutter and applying, to the photoelectric conversion unit, an enabling voltage for enabling movement of the charge generated by the photoelectric conversion unit, (ii) finish the first exposure by applying, to the photoelectric conversion unit, a disabling voltage for disabling movement of the charge generated by the photoelectric conversion unit, with the mechanical shutter open, (iii) obtain a first still image by reading pixel signals from the pixels, and (iv) cause the reset unit to reset the charge stored in all of the pixels; and (2) (i) start second exposure by applying, to the photoelectric conversion unit, an enabling voltage for enabling movement of the signal charge generated by the photoelectric conversion unit, with the mechanical shutter open and (ii) finish the second exposure by applying, to the photoelectric conversion unit, a disabling voltage for disabling movement of the signal charge generated by the photoelectric conversion unit, with the mechanical shutter open, and (iii) obtain a second still image by reading pixel signals from the pixels.

It is to be noted that not only the imaging apparatus including these unique units can be realized, but also a method of driving the imaging apparatus can be realized as a method including the steps corresponding to the unique units of the imaging apparatus.

General and specific aspect(s) disclosed above may be implemented using a system, a method, an integrated circuit, a computer program, or a computer-readable recording medium such as a CD-ROM, or any combination of systems, methods, integrated circuits, computer programs, or computer-readable recording media.

Additional benefits and advantages of the disclosed embodiments will be apparent from the Specification and Drawings. The benefits and/or advantages may be individually obtained by the various embodiments and features of the Specification and Drawings, which need not all be provided in order to obtain one or more of such benefits and/or advantages.

### BRIEF DESCRIPTION OF DRAWINGS

These and other advantages and features will become apparent from the following description thereof taken in conjunction with the accompanying Drawings, by way of non-limiting examples of embodiments disclosed herein.

[FIG. 1]

FIG. 1 is a block diagram of an imaging apparatus according to Embodiment 1.

[FIG. 2]

FIG. 2 is a cross-sectional diagram of a unit cell of a solid-state imaging device according to Embodiment 1.

[FIG. 3]

FIG. 3 is a drive timing chart in still image capturing by a general imaging apparatus.

[FIG. 4]

FIG. 4 is a drive timing chart in still image capturing by an imaging apparatus according to Embodiment 1.

[FIG. 5]

FIG. 5 is a drive timing chart in still image capturing by an imaging apparatus according to Embodiment 2.

[FIG. 6]

FIG. 6 is a drive timing chart in still image capturing by an imaging apparatus according to Embodiment 3.

[FIG. 7A]

FIG. 7A illustrates a reference black level image captured by the solid-state imaging device according to Embodiment 3.

[FIG. 7B]

FIG. 7B illustrates a black level image captured by the solid-state imaging device according to Embodiment 3.

[FIG. 7C]

FIG. 7C illustrates a normal exposure image captured by a solid-state imaging device according to Embodiment 3.

[FIG. 7D]

FIG. 7D illustrates a corrected image captured by the solid-state imaging device according to Embodiment 3.

[FIG. 8]

FIG. 8 is a drive timing chart in still image capturing by an imaging apparatus according to Embodiment 4.

[FIG. 9]

FIG. 9 illustrates an image captured by the solid-state imaging device according to Embodiment 4.

[FIG. 10]

FIG. 10 is a cross-sectional diagram of a conventional solid-state imaging device disclosed in Patent Literature 1.

### DESCRIPTION OF EMBODIMENTS

### Underlying Knowledge Forming Basis of the Present Disclosure

The solid-state imaging device and the imaging apparatus according to each of the embodiments are described below with reference to the drawings. In the present disclosure, descriptions are given using the exemplary embodiments below and the attached drawings for illustrative purpose. Accordingly, all of these are not intended to limit the scope of the present disclosure.

These general and specific aspects may be implemented using a system, a method, an integrated circuit, a computer program, or a computer-readable recording medium such as a CD-ROM, or any combination of systems, methods, integrated circuits, computer programs, or computer-readable recording media.

Hereinafter, certain exemplary embodiments are described in greater detail with reference to the accompanying Drawings.

Each of the exemplary embodiments described below shows a general or specific example. The numerical values, shapes, materials, structural elements, the arrangement and connection of the structural elements, steps, the processing order of the steps etc. shown in the following exemplary embodiments are mere examples, and therefore do not limit the scope of the appended Claims and their equivalents. Therefore, among the structural elements in the following exemplary embodiments, structural elements not recited in any one of the independent claims are described as arbitrary structural elements.

### Embodiment 1

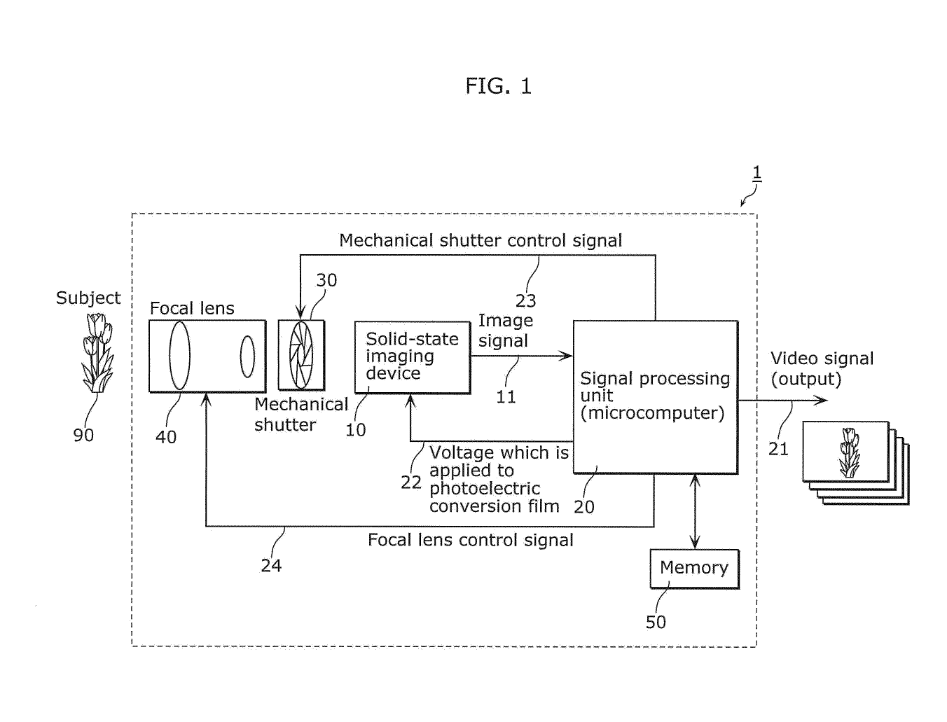

First, a structure of an imaging apparatus according to Embodiment 1 is described with reference to FIG. 1.

FIG. 1 is a block diagram of an imaging apparatus according to Embodiment 1. The imaging apparatus 1 illustrated in the diagram includes: a solid-state imaging device 10; a signal processing unit 20; a mechanical shutter 30; a focal lens 40; and a memory 50.

The solid-state imaging device 10 includes pixels arranged in a matrix above a substrate. Each pixel includes (i) a photoelectric conversion unit which performs photoelectric conversion of incident light into signal charge and (ii) a reset unit which resets charge stored in the photoelectric conversion unit.

When a subject 90 is imaged, a signal of light passed through the focal lens 40 and the mechanical shutter 30 is converted into an image signal 11 by the solid-state imaging device 10, and is subjected to signal processing by the signal processing unit 20, so that a video signal 21 is output. A memory 50 is used for the signal processing as necessary. The signal processing unit 20 supplies and controls a voltage 22 to be applied to a photoelectric conversion film of the solid-state imaging device 10. In addition, the signal processing unit 20 performs interlocking control on a mechanical shutter control signal 23 for controlling the mechanical shutter 30, a focal lens control signal 24 for controlling the focal lens 40, and the voltage 22 to be applied to the photoelectric conversion film. In other words, the signal processing unit 20 is a timing control unit which controls timing for opening and closing the mechanical shutter 30, applying voltages to the photoelectric conversion unit, and performing a pixel reset. Details for the interlocking control will be described later.

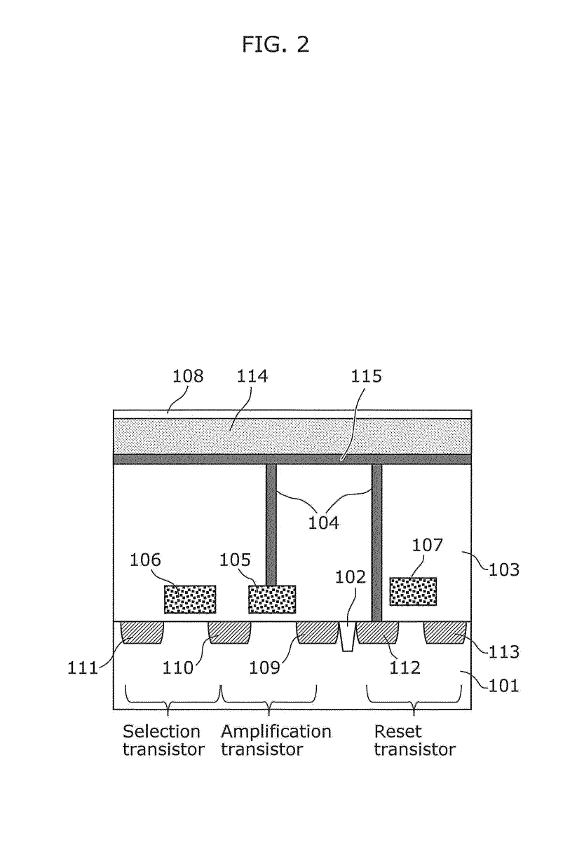

Next, a cross-sectional structure of the solid-state imaging device 10 is described in detail with reference to FIG. 2.

FIG. 2 is a cross-sectional diagram of a unit cell of the solid-state imaging device according to Embodiment 1. As illustrated in FIG. 2, an amplification transistor, a selection transistor, and a reset transistor are formed above a semiconductor substrate 101. The amplification transistor includes a gate electrode 105, a diffusion layer 109 which is a drain, and a diffusion layer 110 which is a source. The selection transistor includes a gate electrode 106, a diffusion layer 110 which is a drain and a diffusion layer 111 which is a source. The diffusion layer 110 servers as both the source of the amplification transistor and the drain of the selection transistor. The reset transistor is a reset unit including a gate electrode 107, a diffusion layer 113 which is a drain, and a diffusion layer 112 which is a source. The diffusion layer 109 and the diffusion layer 112 are isolated by an element isolation area 102. Above the semiconductor substrate 101, an insulation film 103 is formed to cover each of the transistors.

In addition, on the insulation film 103, the photoelectric conversion unit is formed. The photoelectric conversion unit includes: a photoelectric conversion film 114 including amorphous silicon etc.; a unit cell electrode 115 formed below and in contact with a bottom surface of the photoelectric conversion film 114; and a transparent electrode 108 formed on an upper surface of the photoelectric conversion film 114. The unit cell electrode 115 is connected, via a contact 104, to the gate electrode 105 of the amplification transistor and the diffusion layer 112 which is a source of the reset transistor. The diffusion layer 112 connected to the gate electrode 107 functions as a storage diode.

The solid-state imaging device 10 includes pixels arranged in a matrix above a substrate. Each pixel includes (i) a photoelectric conversion unit which performs photoelectric conversion of incident light into signal charge and (ii) a reset unit which resets charge stored in the photoelectric conversion unit.

When light from a subject enters the solid-state imaging device 10, the incident light is absorbed in the photoelectric conversion film 114, producing carrier according to the amount of absorbed light. The carrier is transferred toward the diffusion layer 112 and is stored in the diffusion layer 112.

Next, a general imaging device is described, to facilitate understanding of the imaging device according to this embodiment.

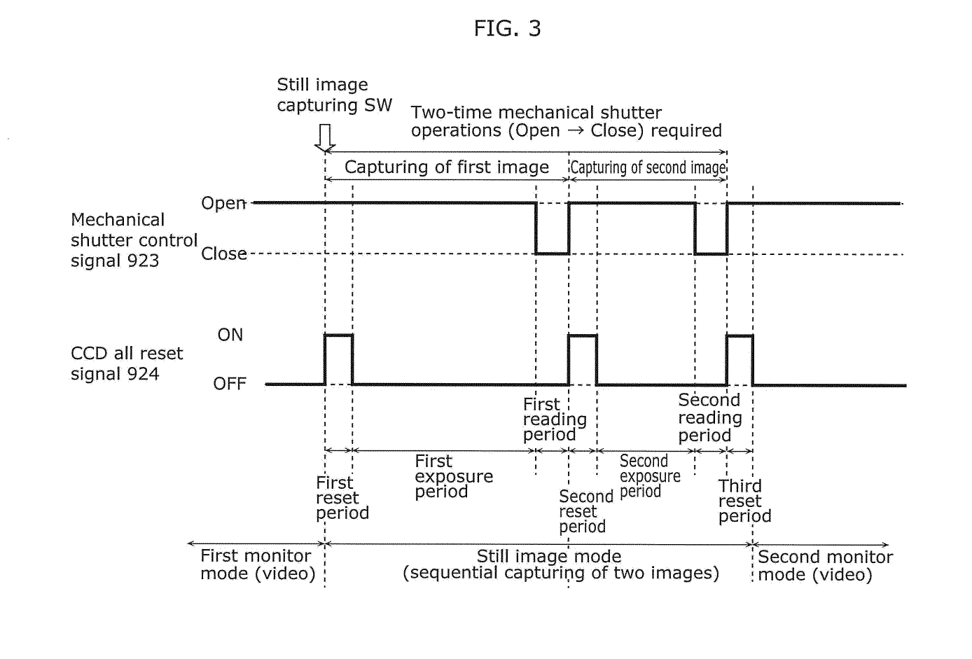

FIG. 3 is a drive timing chart in still image capturing by the general imaging device. Specifically, this diagram is a drive timing chart in the case where the general imaging device sequentially captures two still images.

First, when a still image capturing switch (SW) is turned on, in a first monitor mode, all reset is performed in the solid-state imaging device (all of the pixels in the solid-state imaging device are reset) with the mechanical shutter open (in a first reset period).

Next, a period (first exposure period) after the all reset is completed and before the mechanical shutter is closed according to a mechanical shutter control signal 923 is exposure time for a first image, and a signal of the first image is read (in a first reading period).

Next, in the case of capturing a second image in sequence, all of the pixels in the solid-state imaging device are reset again with the mechanical shutter open according to a CCD all reset signal 924 (in a second reset period).

Next, a period (second exposure period) after the second all reset is completed and before the mechanical shutter is closed secondly according to a mechanical shutter control signal 923 is exposure time for a second image, and a signal of the second image is read (in a second reading period).

Next, all reset is performed again with the mechanical shutter open according to a CCD all reset signal 924 (in a third reset period), and then a return is made to a normal second monitor mode.

In the imaging operation, the mechanical shutter is required to determine exposure time. Specifically, the first mechanical shutter operation is required to capture the first still image, and the second mechanical shutter operation is required to capture the second still image. In other words, two mechanical shutter operations are required to capture two still images sequentially.

However, in sequential capturing of still images of a high-speed object, a physical time lag occurs due to a constraint of a dynamic mechanism of the mechanical shutter. Thus, when such a moving object is imaged, blurs and distortions occur in the image of the object. The number of times of opening and closing a mechanical shutter affects the lifetime of a mechanical shutter unit.

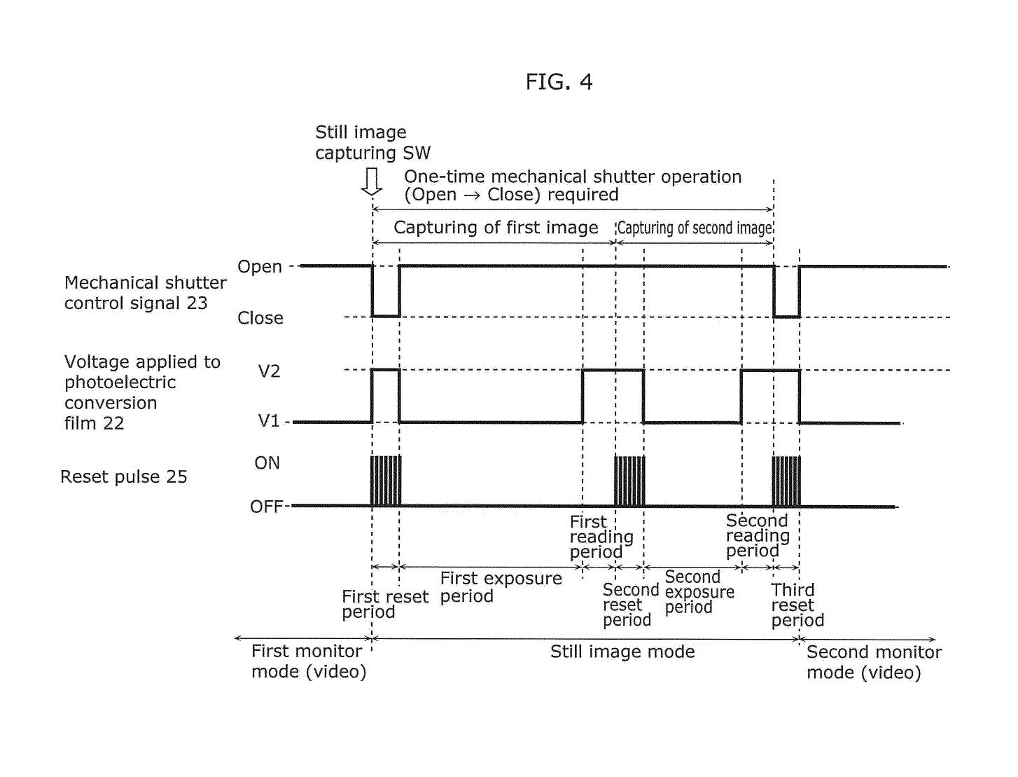

Next, a case where the imaging apparatus according to this embodiment captures images sequentially is described with reference to FIG. 4.

FIG. 4 is a drive timing chart in still image capturing by the imaging apparatus according to Embodiment 1. It is to be noted that, among voltages 22 which are applied to the photoelectric conversion film, a voltage which disables movement of carriers generated by the photoelectric conversion film 114 is determined to be V2, and a voltage which enables movement of carrier electrons or holes generated by the photoelectric conversion film 114 is determined to be V1. Setting, to V2, the voltage 22 which is applied to the photoelectric conversion film causes a feedback reset on a per line basis, which allows the solid-state imaging device 10 to obtain excellent characteristics to random reset noise.

First, when a still image capturing SW is ON in the first monitor mode, a feedback reset on a per line basis is executed (a first reset period) by closing the mechanical shutter 30 according to a mechanical shutter control signal 23, and setting, to V2, the voltage 22 which is applied to the photoelectric conversion film. In this way, an all reset operation is completed in the solid-state imaging device 10. Precisely reducing noise such as random noise by this all reset operation is extremely effective to enhance an image quality in a later-described case of capturing a plurality of images.

In this embodiment, the mechanical shutter 30 is closed in order to increase the effect of reducing random reset noise in the solid-state imaging device 10, instead of determining exposure time as in a general imaging apparatus disclosed in FIG. 3.

In addition, the random reset noise is reduced, and the number of times of opening and closing the mechanical shutter is reduced, by performing interlocking control on open and close drives of the mechanical shutter 30 and the voltage 22 which is applied to the photoelectric conversion film. On the other hand, a simple configuration of a mechanical shutter and a solid-state imaging device cannot provide the effect obtainable in this embodiment.

Next, after the completion of the all reset, exposure on a first image is started by setting the voltage 22 which is applied to the photoelectric conversion film to V1 and opening the mechanical shutter 30. A period until when the voltage 22 to be applied to the photoelectric conversion film is set to V2 corresponds to a first exposure period.

Next, the first image is read (a first reading period) with the voltage 22 set to V2 applied to the photoelectric conversion film. At this time, there is no need to close and open the mechanical shutter 30 in the first reading period, as in the general imaging apparatus disclosed in FIG. 3.

Next, after the reading of the first image is completed, a feedback reset is executed on a per line basis in order to capture a second image (a second reset period). When the second image is captured in sequence, after the all reset in the second reset period is completed, the voltage 22, which is applied to the photoelectric conversion film, is set to V1, and exposure on the second image is started with the mechanical shutter 30 open. A period until when the voltage 22, which is applied to the photoelectric conversion film, is set to V2 corresponds to a second exposure period.

Next, the second image is read (a second reading period) with the voltage 22 set to V2 applied to the photoelectric conversion film.

Next, after the reading of the second image is completed, a feedback reset is executed on a per line basis (a third reset period). When the sequential capturing is finished and a return to the second monitor mode is made, and in the case of performing a reset operation in the third reset period, for example, the mechanical shutter 30 is closed, and, after the completion of the reset, the mechanical shutter 30 is opened.

The interlocking control on the mechanical shutter 30 and the voltage 22 which is applied to the photoelectric conversion film makes it possible to perform sequential capturing of two still images by a one-time operation of the mechanical shutter. Although the example of driving for sequential capturing of two images has been described in this embodiment, it is to be noted that such a drive can be realized by a one-time operation of the mechanical shutter even in the case of sequential capturing of three or more images.

In addition, it is the signal processing unit 20 that performs interlocking control on the mechanical shutter control signal 23 and the voltage 22 which is applied to the photoelectric conversion film. The signal processing unit 20 becomes a host for the solid-state imaging device 10 in this embodiment.

In other words, in the case of switching from the mode for monitoring an image to the mode for capturing a still image, the signal processing unit 20 (1) closes the mechanical shutter 30, and applies, to the photoelectric conversion film 114, a voltage V2 for disabling movement of electric charge generated by the photoelectric conversion film 114. In this way, the electric charge stored in all of the pixels is reset.

In addition, in the case of sequentially capturing a plurality of still images, the signal processing unit 20 (2) opens the mechanical shutter 30, and applies, to the photoelectric conversion film 114, a voltage V1 for enabling movement of the electric charge generated by the photoelectric conversion film 114. In this way, the first exposure is executed. Next, (3) with the mechanical shutter 30 open, the signal processing unit 20 applies, to the photoelectric conversion film 114, a voltage V2 for disabling movement of the electric charge generated by the photoelectric conversion film 114. In this way, the first exposure is finished, pixel signals are read from the pixels, and thereby a first still image is obtained. Next, (4) the reset unit is caused to reset the electric charge stored in all of the pixels. Consequently, (5) with the mechanical shutter 30 open, the voltage V1 is applied to the photoelectric conversion film 114. In this way, the second exposure is executed. Consequently, (6) with the mechanical shutter 30 open, the voltage V2 is applied to the photoelectric conversion film 114. In this way, the second exposure is finished, pixel signals are read from the pixels, and thereby a second still image is obtained.

In the imaging apparatus 1 according to this embodiment, when the still image capturing SW is pressed, the signal processing unit 20 performs interlocking control on the mechanical shutter control signal 23 and the voltage 22 which is applied to the photoelectric conversion film, as in the drive timing chart illustrated in FIG. 4. In this way, it is possible to reduce random noise unique to solid-state imaging devices, and further to capture a plurality of still images with a one-time mechanical shutter operation.

In addition, the number of still images to be captured sequentially can be freely set by means of an imaging person outside giving an instruction to the signal processing unit 20.

As described above, the imaging apparatus and the solid-state imaging device according to this embodiment make it possible to skip plural times of mechanical shutter operations by interlocking control on voltages which are applied to the mechanical shutter and the photoelectric conversion film. In addition, a physical time lag is reduced. Thus, when a moving object is imaged, blurs and distortions of the subject are reduced, and fast imaging can be performed. Furthermore, since it is possible to reduce the number of times of opening and closing the mechanical shutter, the mechanical shutter has a longer physical lifetime.

### Variation of Embodiment 1

Furthermore, how to realize a high dynamic range in still image capturing is described.

An exemplary case where a high dynamic range is required in a still image is a case where an image of the inside of a room and outside a window is captured at the same time from the inside of the room. When the bright outside of the window in the image captured with the amount of exposure adjusted to the dark room, blown-out highlights occur in the image part of the bright outside of the window due to the exposure. On the other hand, when the inside of the dark room in the image captured with the amount of exposure adjusted to the bright outside of the window, the image part of the inside of the dark room may be unclear due to the exposure.

In view of this, in the drive timing chart in FIG. 4, the second still image is captured by setting one of different exposure periods which are set respectively for the capturing of the first image and the capturing of the second image. More specifically, the first image is captured by lengthening the first exposure period to adjust the amount of exposure to the dark inside of the room. Next, the second image is captured by shortening the second exposure period to adjust the amount of exposure to the bright outside the window. A single image having a high dynamic range is generated by combining the captured two images in the solid-state imaging device or in the imaging apparatus. In the imaging device 1 illustrated in

FIG. 1, for example, the signal processing 20 can combine the images using the memory 50. Alternatively, when a signal processing function and a memory function are mounted on the solid-state imaging device 10, the solid-state imaging device 10 may combine the images.

In addition, the exposure periods for the first image and the second image are controlled by the signal processing unit 20 using the voltage 22 which is applied to the photoelectric conversion film.

When still images of a high-speed object are captured sequentially by the imaging device according to this embodiment, interlocking control is performed on the voltage which is applied to the photoelectric conversion film and opening and closing the mechanical shutter. This eliminates plural times of mechanical shutter operations, resulting in the reduction in physical time lag. In addition, when images of the moving object are captured, blurs and distortions of the subject are reduced when combining the images.

When two images captured with different amounts of exposure are combined, motion blurs may produce false colors around the contours of the subjects etc. in a more noticeable manner. In contrast, since fast imaging is possible in this embodiment, it is possible to reduce blurs and distortions of subjects and such false colors around the contours of the subjects etc. when images are combined, more significantly than conventional configurations. In addition, the number of times of opening and closing the mechanical shutter is only once, and thus it is possible to reduce image blurs due to vibrations etc. caused when the mechanical shutter is opened and closed.

In this variation, a simple example of two images with different exposure periods is described. Preferably, two or more still images with different exposure periods are captured and combined when a high-definition dynamic range mode is realized. It is clear that two or more images can be captured physically with a one-time mechanical shutter operation using the configuration in Embodiment 1. In other words, the signal processing unit 20 may generate m still images by performing sequential imaging n times with the mechanical shutter 30 open, obtaining n still images each having an exposure period different from those of the other still images, combining the n still images (here, n is a natural number of 2 or larger, and m is a natural number satisfying n≧m).

In addition, in this variation, the first exposure period that is longer and the second exposure period that is shorter are used in this order when capturing the first image and the second image, respectively. Alternatively, the order of the longer and shorter exposure periods may be inverted. The imaging apparatus and the solid-state imaging device in this embodiment make it possible to capture a plurality of still images with different exposure periods, and to set the order of the exposure periods freely irrespective of the lengths of the exposure periods.

For example, in FIG. 4, the mechanical shutter 30 is closed in the first reset period in order to increase the effect of reducing random reset noise in the solid-state imaging device 10, instead of determining exposure periods as in a conventional solid-state imaging device. In this respect, it is sometimes better to process a frame with a small amount of exposure firstly because such a frame is to have more noticeable random reset noise.

As described above, according to this variation, when the still image capturing SW is pressed, the signal processing unit 20 performs interlocking control on the mechanical shutter control signal 23 and the voltage 22 which is applied to the photoelectric conversion film as illustrated in the drive timing chart in FIG. 4. In this way, it is possible to reduce random noise unique to solid-state imaging devices, and further to capture a plurality of still images having different exposure periods with a one-time mechanical shutter operation. In contrast, a configuration obtained by simply combining a mechanical shutter and a solid-state imaging device cannot provide the advantageous effects disclosed herein. In addition, the number of still images to be captured sequentially and exposure periods for the respective still images can be freely set by means of an imaging person outside giving an instruction to the signal processing unit 20.

In other words, in this variation, such interlocking control on the mechanical shutter 30 and the voltage 22 which is applied to the photoelectric conversion film makes it possible to capture a plurality of images with different exposure periods with a one-time mechanical shutter operation. In this way, by combining the data of two or more images having different exposure periods, it is possible to generate an image having a high dynamic range with which subjects at bright and dark places can be presented in the images. In other words, it is possible to generate a high-definition still image having a high dynamic range by combining a plurality of still images with a small time lag.

### Embodiment 2

Hereinafter, with reference to the drawings, configurations of an imaging apparatus and a solid-state imaging device according to Embodiment 2 and operations performed thereby are described focusing on differences from those in Embodiment 1.

When a plurality of images are captured in order to obtain a higher dynamic range, exposure period control is inevitably uneven.

In other words, when such still images having different exposure periods are combined, and when the subject is a moving object, the difference between the exposure periods may correspond to the amount of motion of the object. In this case, it may be difficult to estimate the motion of the subject between the still images, and match the positions of the moving subject using signal processing when combining the still images.

In view of this, the imaging apparatus according to this embodiment is intended to capture a plurality of images obtained through different amounts of exposure using an even exposure period with a one-time mechanical shutter operation, by performing interlocking control on opening and closing the mechanical shutter and the voltage which is applied to the photoelectric conversion film.

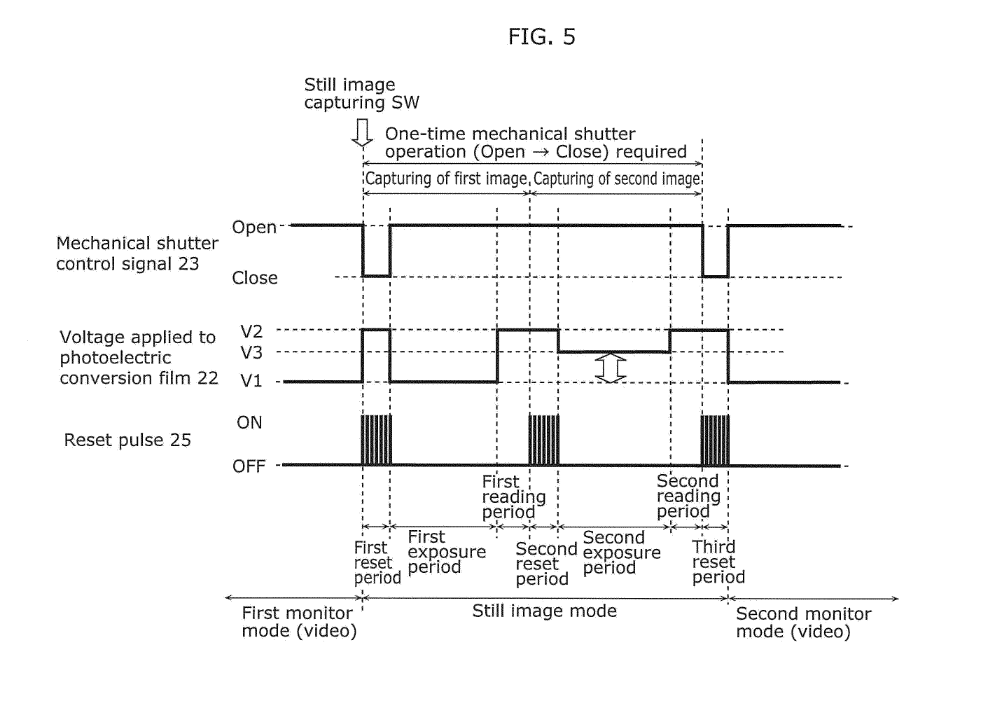

In other words, when the exposure period is constant, the amount of motion of the moving subject is highly likely to be constant. Thus, it becomes easy to estimate the motion and match the positions of the subject. First, operations performed by the imaging apparatus and the solid-state imaging device according to Embodiment 2 are described with reference to FIG. 5.

FIG. 5 is a drive timing chart in still image capturing by the imaging apparatus according to Embodiment 2. In the drive timing chart, a drive for enabling capturing of a plurality of still images with a one-time mechanical shutter operation is basically the same as in Embodiment 1. A difference is that voltages 22 which are applied to the photoelectric conversion film vary between the capturing of a first image and the capturing of a second image. More specifically, the voltages 22 which are applied to the photoelectric conversion film in a first exposure period and a second exposure period are adjusted according to the amounts of exposure. In addition, the efficiency of converting the amounts of exposure between the capturing of the first image and the capturing of the second image are determined by the signal processing unit 20 using the voltages 22 which are applied to the photoelectric conversion film according to the amounts of exposure.

The solid-state imaging device according to this embodiment changes the voltage values of the voltages 22 which are applied to the photoelectric conversion film, and thereby controls the amounts of movement of carriers and controls the conversion efficiencies. Control on this conversion efficiency makes it possible to virtually control the amounts of exposure without changing the exposure periods.

Here is assumed an exemplary case where an image of the inside of a room and outside the window is captured from the inside of the room at the same time. When the image is captured with the amount of exposure adjusted to the dark room, the image part of the bright outside of the window has blown-out highlights due to the exposure. On the other hand, when the image is captured with the amount of exposure adjusted to the bright outside of the window, the image part of the inside of the dark room may not be captured.

In the imaging operation according to this embodiment, two still images having different conversion efficiencies are captured in the capturing of the first image and the capturing of the second image illustrated in FIG. 5. More specifically, the voltage 22 which is applied to the photoelectric conversion film is set to a voltage value V1 in a state of a high conversion efficiency and imaging is performed with the amount of exposure adjusted to the dark inside of the room; and the voltage 22 which is applied to the photoelectric conversion film is set to a voltage value V3 in a state of a low conversion efficiency and imaging is performed with the amount of exposure adjusted to the bright outside of the window. A single image having a high dynamic range is generated by combining the captured two images in the solid-state imaging device or in the imaging apparatus.

When still images of a high-speed object are captured sequentially by the imaging device according to this embodiment, interlocking control is performed on the voltage which is applied to the photoelectric conversion film and mechanical shutter operations. This eliminates plural-time mechanical shutter operations, resulting in the reduction in physical time lag. In addition, when images of the moving object are captured, blurs and distortions of the subject are reduced. In general, when two images captured with different amounts of exposure are combined, motion blurs may cause false colors around the contours of the subjects etc. in a more noticeable manner. In contrast, the imaging device according to this embodiment enables fast imaging, and thus is capable of ensuring higher image quality than those obtainable by conventional configurations. Furthermore, the number of times of opening and closing the mechanical shutter is only once, and thus it is possible to reduce image blurs caused when the mechanical shutter is opened and closed.

In this embodiment, an example of two images with different conversion efficiencies is described simply. Preferably, two or more still images with different conversion efficiencies are captured and combined when a high-definition dynamic range mode is realized. It is clear that two or more images can be captured physically with a one-time mechanical shutter operation using the configuration in Embodiment 2. In other words, the signal processing unit 20 may perform sequential imaging n times with the mechanical shutter 30 open. More specifically, it is also good to generate m still images by obtaining n still images with different values of voltages which are applied to the photoelectric conversion film 114 during the n-time sequential imaging and combining the n still images (n is a natural number of 2 or larger, and m is a natural number satisfying n≧m).

In addition, in this embodiment, the first exposure period in which the conversion efficiency of the photoelectric conversion film is higher and the second exposure period in which the conversion efficiency of the photoelectric conversion film is lower are used in this order when capturing the first image and the second image, respectively. Alternatively, the order of the higher and lower conversion efficiencies may be inverted. The imaging apparatus and the solid-state imaging device in this embodiment make it possible to capture a plurality of still images with different conversion coefficients for the amounts of exposure, and to set the order of the conversion coefficients freely irrespective of the magnitudes of the conversion efficiencies.

For example, in FIG. 5, the mechanical shutter 30 is closed in the first reset period in order to increase the effect of reducing random reset noise in the solid-state imaging device 10, instead of determining exposure periods as in a conventional solid-state imaging device. In this respect, it is sometimes better to process a frame with a low conversion efficiency firstly because such a frame is to have more noticeable random reset noise.

In addition, from a viewpoint of control performed by the voltage 22 which is applied to the photoelectric conversion film, it is assumed that imaging may be faster when performing operations according to an ascending order of the amounts of variation in the voltage 22 which is applied to the photoelectric conversion film. When the amounts of variation in the voltage 22 which is applied to the photoelectric conversion film is large, the internal circuit of the solid-state imaging device 10 becomes inconstant, which may deteriorate the image quality. Thus, it is better to perform operations according to an ascending order of the amounts of variation in the voltage 22 which is applied to the photoelectric conversion film.

As described above, according to this embodiment, when the still image capturing SW is pressed, the signal processing unit 20 performs interlocking control on the mechanical shutter control signal 23 and the voltage 22 which is applied to the photoelectric conversion film as illustrated in the drive timing chart in FIG. 5. In this way, it is possible to reduce random noise unique to solid-state imaging devices, and further to capture a plurality of still images having different conversion coefficients in the amounts of exposure with a one-time mechanical shutter operation. In contrast, a configuration obtained by simply combining a mechanical shutter and a solid-state imaging device cannot provide the advantageous effects disclosed herein. In addition, the number of still images to be captured sequentially and conversion coefficients in the amounts of exposure for the respective still images can be freely set by means of an imaging person outside giving an instruction to the signal processing unit 20.

In other words, in this embodiment, the voltage 22 which is applied to the photoelectric conversion film is controlled with the constant exposure period, by performing interlocking control on the mechanical shutter 30 and the voltage 22. In this way, it becomes possible to realize capturing of a plurality of images having different conversion efficiencies in the photoelectric conversion film with a one-time mechanical shutter operation. In this way, it is possible to generate a still image having a high dynamic range by capturing a plurality of still images under uniform exposure period control and combining the still images. In addition, since the exposure period is constant, if the speed of a moving subject is constant, it is significantly easy to estimate a motion thereof, combine images, and process the signals of the images when generating a combined image.

### Embodiment 3

Hereinafter, with reference to the drawings, configurations of an imaging apparatus and a solid-state imaging device according to Embodiment 3 and operations performed thereby are described focusing on differences from those in the above-described embodiments.

First, an extremely small dark current is generated in photodiodes (the photoelectric conversion film) of the solid-state imaging device even in dark time in which no photoelectric conversion is structurally performed. It is impossible to prevent the image quality from deteriorating due to the occurrence of the dark current, unless the video signal is corrected by clamping to a proper black level. In order to detect and remove the dark current to adjust to the black level of the video signal, a value of dark current is detected from an area called Optical Black (OB) area which is an optically shielded area and in which the dark current occurs as in a normal pixel unit. By subtracting the value of the dark current from outputs from a valid pixel unit which are used for an actual video, the black level of the video signal is corrected by clamping.

Here, values of outputs from the OB area are summed and averaged to detect the dark current level in order to reduce the variation in the current. Thus, when the OB area is small, the accuracy of measuring the dark current deteriorates. From this viewpoint, although a reduction in an OB area leads to decrease in an image quality, the solid-state imaging devices need to be made smaller in order to develop compact cameras desired in the market. Thus, the size of a chip in the OB area in the solid-state imaging device is also considered.

Furthermore, the dark current has a temperature dependence. Thus, gain multiplication for image enhancement may produce an error in the value of the dark current. For this reason, the use of image processing by subtracting the value of a dark current measured in the past or a constant value predetermined as a dark current level from an output from the valid pixel unit which is used for an actual video produces an error in a resulting correction value, leading to deterioration in image quality.

In addition, the OB area and the valid pixel area are positioned at physically different areas. For this reason, when the valid pixel area is large, even with very small structural differences in chip layouts or variation in manufacturing processes, it is impossible to perform proper black level correction, which makes the black level in a frame uneven or causes so-called luminance shading.

The solid-state imaging device and the imaging apparatus according to this embodiment were made in view of the above. Hereinafter, operations performed thereby are described in detail.

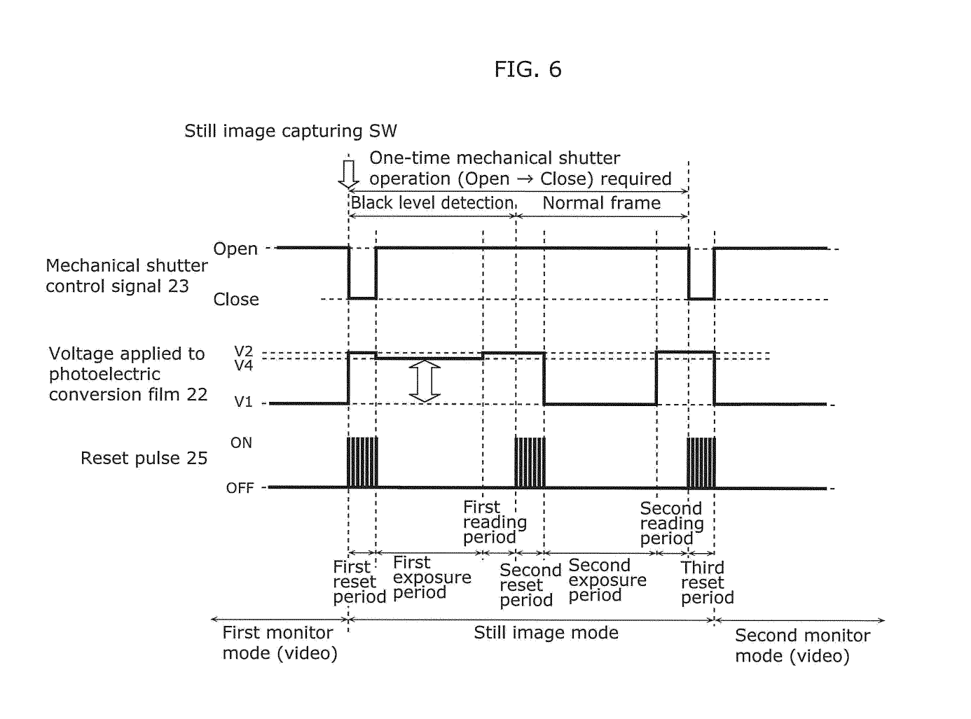

FIG. 6 is a drive timing chart in still image capturing by the imaging apparatus according to Embodiment 3. In the chart, with a constant exposure period, by performing interlocking control on the mechanical shutter 30 and the voltage 22 which is applied to the photoelectric conversion film, a plurality of images are captured with different conversion efficiencies of photoelectric conversion film with a one-time mechanical shutter operation. A drive for enabling capturing of a plurality of still images with a one-time mechanical shutter operation is the same as those in Embodiments 1 and 2. A difference is that voltages 22 which are applied to the photoelectric conversion film vary between the capturing of a first image and the capturing of a second image. More specifically, the voltage 22 which is applied to the photoelectric conversion film in a black level period is set to a voltage value V4 for enabling output of the black level signal, and the voltage 22 which is applied to the photoelectric conversion film in a normal exposure period is set to a voltage value V1 for enabling normal exposure. In other words, V4 is a value at which the black level signal of the video signal is output from the pixels as an image signal.

Furthermore, the solid-state imaging device according to this embodiment changes the voltage values of the voltages 22 which are applied to the photoelectric conversion film as in Embodiment 2, and thereby controls the conversion efficiencies. Control on conversion efficiencies makes it possible to virtually control the amounts of exposure without changing the exposure periods.

Thus, the solid-state imaging device according to this embodiment is capable of controlling the conversion efficiencies by means of the photoelectric conversion film shielded by electrodes and further controlling the amounts of movement of carriers by controlling voltages which are applied to the photoelectric conversion film. Thus, the solid-state imaging device is capable of outputting a black level of a video signal even when it is not optically shielded as in a general solid-state imaging device (for example, an OB area of a CCD image sensor).

Hereinafter, signal processing according to this embodiment is described with reference to FIGS. 1, 6, and 7A to 7D.

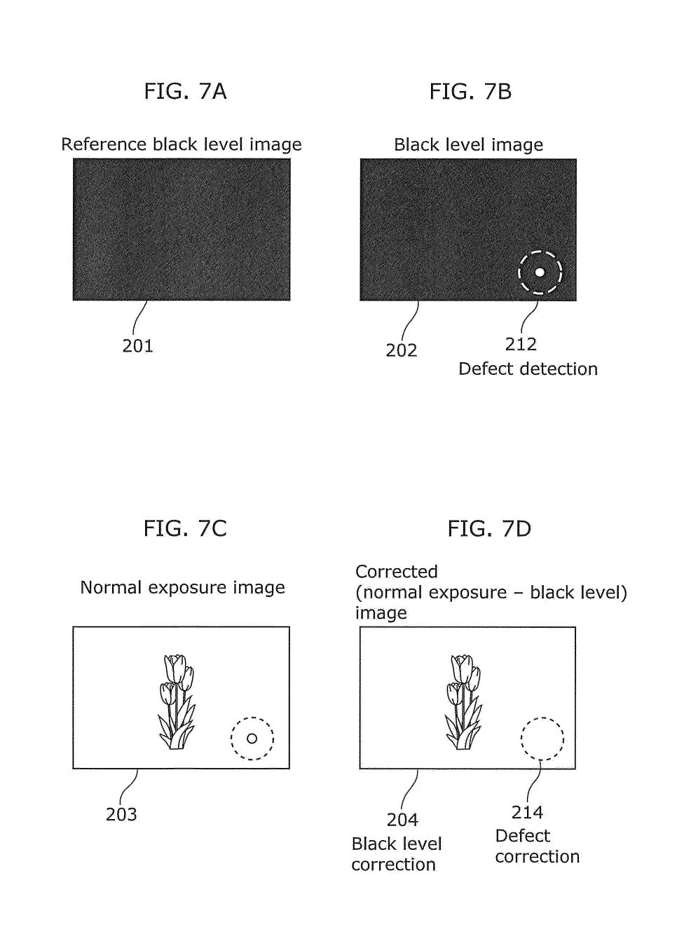

FIG. 7A illustrates a reference black level image captured by the solid-state imaging device according to Embodiment 3. In addition, FIG. 7B illustrates a black level image captured by the solid-state imaging device according to Embodiment 3. In addition, FIG. 7C illustrates a normal exposure image captured by the solid-state imaging device according to Embodiment 3. In addition, FIG. 7D illustrates a corrected image captured by the solid-state imaging device according to Embodiment 3. More specifically, the black level image 202 in FIG. 7B is an image which is output when the voltage 22 which is applied to the photoelectric conversion film in FIG. 6 is set to V4.

With the data of a reference black level image 201 for each pixel stored in advance in the solid-state imaging device or the imaging apparatus, it is possible to perform defect detection 212 by subtracting, for each pixel, the data of the reference black level image 201 from the black level image 202. By detecting the pixel position of the defect, it is possible to perform defect correction 214 as in the corrected image illustrated in FIG. 7D.

In defect correction in a general imaging device, the address indicating the position of a defect is detected in a shielded state during dark time at the time of a product shipment check performed at a factory. In this case, it is impossible to detect and correct defects which occur after the product shipment, for example, a breakdown of the pixel unit caused by flowing cosmic radiation etc. In addition, such defects may be caused by dust flowing inside the package, and such defects due to movement of the dust cannot be corrected.

On the other hand, the solid-state imaging device according to this embodiment is capable of capturing a plurality of still images with a one-time mechanical shutter operation, as described in Embodiments 1 and 2. Utilizing this, as in this embodiment, it is possible to always correct defects in real time by subtracting, for each pixel, the data of the reference black level image 201 from the data of the black level image 202. In other words, the signal processing unit 20 performs signal processing on the images other than the black level image 202, with reference to the black level image 202.

In addition to the above-described address-based defect correction method, examples of defect detection by general imaging devices include a dynamic defect correction method for correcting defects evenly in the whole frame. However, in this case, a median filter or a low-pass filter is disposed evenly on the whole frame, and thus the resolution of the whole frame may be decreased.

On the other hand, the solid-state imaging device according to this embodiment is capable of capturing a plurality of still images with a one-time mechanical shutter operation. Utilizing this, as in this embodiment, it is possible to correct, for only each of pixels detected to be defective, a defect of image data of an image portion corresponding to the defective pixel by subtracting, for the pixel, the data of the reference black level image 201 from the data of the black level image 202. Thus, it is possible to suppress the deterioration in the resolution. In this way, the resolution of the whole frame does not deteriorate. In other words, the signal processing unit 20 obtains a corrected image 204 by calculating, for the pixel, a difference between the data of the black level image 202 and the data of the normal exposure image 203, determining the pixel having a difference value exceeding a predetermined value to be the defective pixel, and correcting the defect of the image data in the normal exposure image 203, the image data being of an image portion corresponding to the defective pixel.

After the output of the black level and the detection of the defect, imaging with normal exposure is executed by performing conversion efficiency control by adjusting the voltage level of the voltage 22 which is applied to the photoelectric conversion film according to the amount of exposure for a subject. A time lag from the black level period to the normal exposure period is a very short duration which is a sum of a first reading period for reading the data of the black level image and a second reset period. The very short duration is an ignorable time difference even in the case where a high-speed moving object is currently being imaged.

In addition, carriers occur even during dark time in which no light enters. These carriers need to be removed to adjust the black level, that is, so-called OB clamp needs to be executed. In this embodiment, it is possible to perform an OB clamp using the image data during the black level period for the image data of the normal exposure period.

In addition, a general solid-state imaging device includes an OB area in which light is shielded at an area other than the valid pixel unit, and OB clamp methods which can be performed thereby include a method for performing an OB clamp on the whole valid pixel unit using an average value of output values from the OB area. In addition, when an OB area is positioned in the horizontal direction of the valid pixel unit, OB clamp methods which can be performed thereby include a method for performing an OB clamp using an average value on a per line basis. In this case, however, another OB area is physically required. Reducing the size of an OB area decreases accuracy in an OB clamp, and thus it is difficult to reduce the size of a solid-state imaging device.

In contrast, the solid-state imaging device according to this embodiment can also use pixels co-located with the valid pixel unit as

OB pixels, and thus it does not require any additional shielded OB area. For this reason, the solid-state imaging device can be made more compact.

Furthermore, the solid-state imaging device according to this embodiment uses the co-located pixels as the OB clamp pixels. Thus, it is also possible to reduce a clamp error even with differences in chip layout designs and manufacturing processes which are made when physically different areas are used as OB clamp areas. An uneven black balance makes luminance biased, resulting in so-called luminance shading. With the configuration in this embodiment, the luminance shading can be reduced.

In addition, in order to obtain wide opening in each pixel of the pixel unit to increase sensitivity thereof, it is general to make a pixel layout considering a plurality of pixels as a pixel unit. However, due to variations in line length and layout, black levels may vary on a per pixel, color, or line basis. On the other hand, with the configuration in this embodiment, such variations can naturally be reduced because a clamp is possible using the pixel black level of the own pixel.

As described above, according to this embodiment, when the still image capturing SW is pressed, the signal processing unit 20 performs interlocking control on the mechanical shutter control signal 23 and the voltage 22 which is applied to the photoelectric conversion film as illustrated in the drive timing chart in FIG. 6. In this way, it is possible to reduce random noise, and further to capture a plurality of different still images with a one-time mechanical shutter operation. In this way, it is possible to perform defect detection and a black level correction clamp on a per pixel unit basis. In contrast, a configuration obtained by simply combining a mechanical shutter and a solid-state imaging device cannot provide the advantageous effects disclosed herein.

In addition, the number of still images to be captured sequentially, ON and/or OFF of a defect detection and a defect correction, and ON and/or OFF of a black level correction can be freely set by means of an imaging person outside giving an instruction to the signal processing unit 20.

In other words, in this embodiment, it is possible to capture two still images that are the black level image 202 and the normal exposure image 203 with the one-time mechanical shutter operation, by performing interlocking control on the mechanical shutter 30 and the voltage 22 which is applied to the photoelectric conversion film. In addition, it is possible to detect a defect 212 in real time by subtracting, for each pixel unit, the data of the prepared reference black level image 201 from the data of the black level image 202, and to thereby perform the defect correction 214. Furthermore, it is possible to correct the black level by clamping the black level using the black level image 202 for the normal exposure image 203. Accordingly, it is possible to provide the compact solid-state imaging device configured to include the valid pixel unit and the black level detecting unit co-located with each other and to be capable of generating high-quality still images having black levels corrected with high accuracies.

### Embodiment 4

Hereinafter, with reference to the drawings, configurations of an imaging apparatus and a solid-state imaging device according to Embodiment 4 and operations performed thereby are described focusing on differences from those in the above-described embodiments.

An auto focus (AF) function for focusing on an image has been remarkably advanced with an increase in the processing speed. However, in order to capture still images, there is a need to capture each of the images with the mechanical shutter closed after focusing on the image. For this reason, in the case where a user captures still images in a short period of time without missing a good opportunity for photographing, and then finds out that the focusing was unsuccessful after the capturing, the user has no choice but to re-capture a similar image or abandon re-capturing a similar image.

In view of this, the solid-state imaging device and the imaging apparatus according to this embodiment make it possible to capture a plurality of still images with a one-time mechanical shutter operation, and realize an appropriate black level correction further using the still images. In addition, correct focusing provides an optimum still image. Hereinafter, operations performed thereby are described in detail.

The solid-state imaging device and the imaging apparatus according to this embodiment perform interlocking control on the mechanical shutter 30 and the voltage which is applied to the photoelectric conversion film. In this way, with the one-time mechanical shutter operation, it is possible to sequentially capture a plurality of images at a high speed while moving the focal lens 40 from a tele (close) side to a wide (distant) side, or inversely. Thus, after the imaging, it is possible to select the image having the optimum focus. Hereinafter, operations by the solid-state imaging device are described with reference to FIGS. 1, 8, and 9.

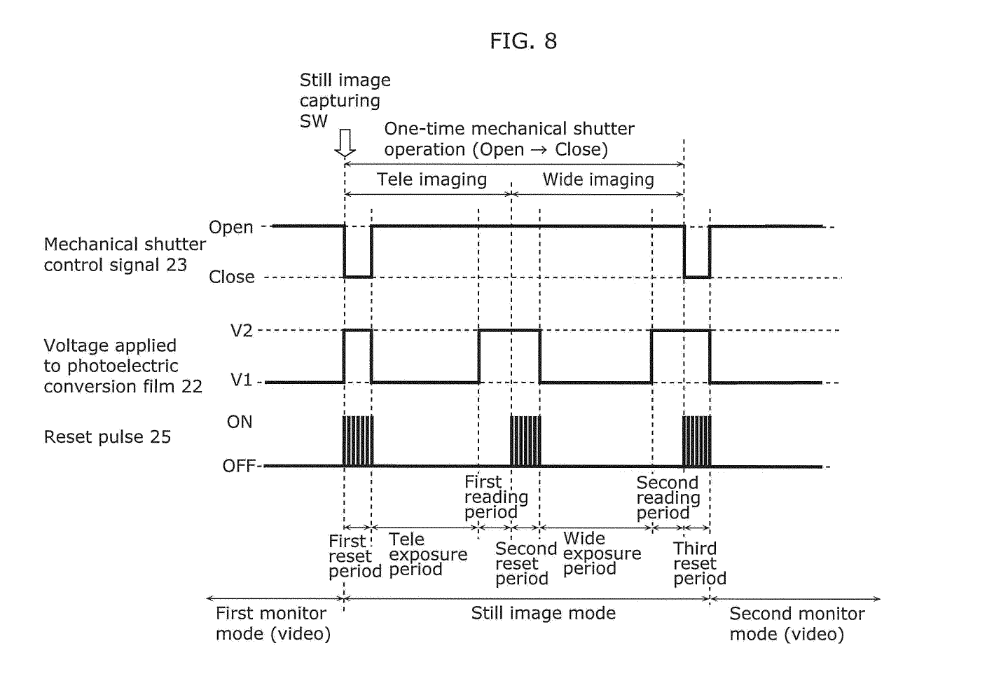

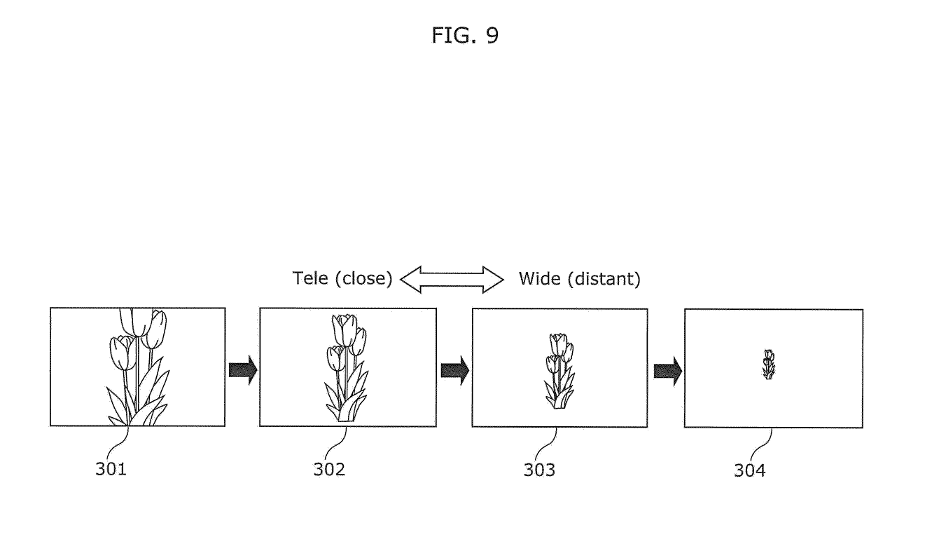

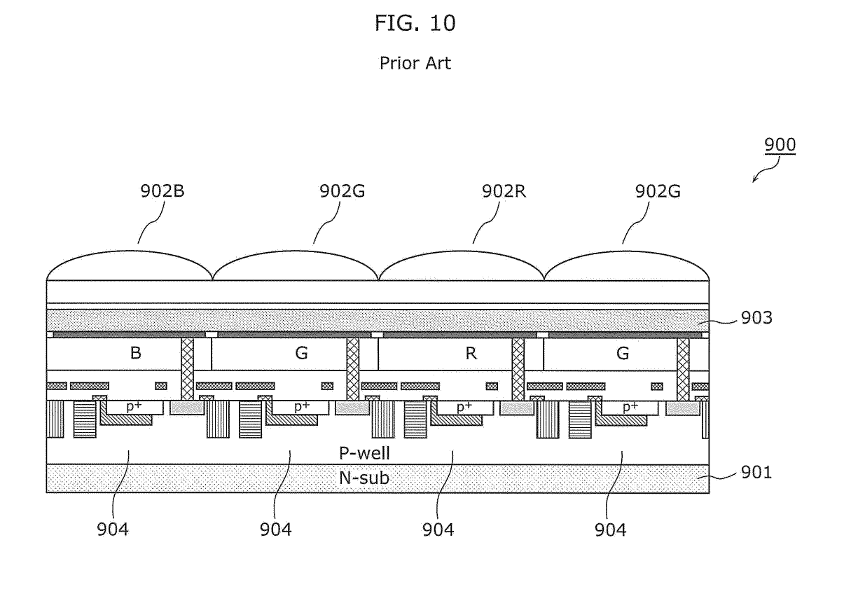

FIG. 8 is a drive timing chart in still image capturing by the imaging apparatus according to Embodiment 4. In addition, FIG. 9 illustrates an image captured by the solid-state imaging device according to Embodiment 3.

The focal lens 40 illustrated in FIG. 1 is controlled by the signal processing unit 20. As known from FIG. 8, after the still image capturing SW is pressed, the signal processing unit 20 performs a reset after closing the mechanical shutter 30 (a first reset period). Then, the signal processing unit 20 opens the mechanical shutter 30, and obtains an image signal by the tele-side imaging (a tele exposure period) and an image signal by the wide-side imaging (a tele exposure period) while moving the focal lens 40 from a position optimum for imaging in the close tele-side to a position optimum for imaging in the distant wide-side (a wide exposure period). Next, the signal processing unit 20 stores these image signals in the memory 50. In other words, when sequentially capturing a plurality of still images, the signal processing unit 20 obtains a first still image exposed in the tele exposure period and a second still image exposed in the wide exposure period while changing the focal length of the focal lens 40. The signal processing unit 20 then stores data of these still images in the memory 50.

Although FIG. 8 illustrates a case of obtaining two still images, the number of images to be captured is not limited. FIG. 9 presents illustrated images in the case where four still images are obtained. In the diagram, the illustrated images present images captured in the order from the tele-side image 301 to the wide-side image 304. The tele-side images 301 and 302 are close-up out-of-focus shots of a subject 90. On the other hand, the wide-side image 304 is a long shot of the subject 90. Thus, it is known that the wide-side image 303 is the optimum still image. An imaging person can extract the wide-side image 303 from the four kind still images stored in the memory 50 in the solid-state imaging device or the imaging apparatus according to this embodiment.

In addition, this embodiment describes an example in which the focal lens 40 is changed from the tele-side image 301 to the wide-side image 304, but may be changed from the wide-side image 304 to the tele-side image 301.

As described above, according to this embodiment, when the still image capturing SW is pressed, the signal processing unit 20 performs interlocking control on the mechanical shutter control signal 23, the voltage 22 which is applied to the photoelectric conversion film, and the position of the focal lens 40, as illustrated in the drive timing chart in FIG. 8. In this way, it is possible to reduce random noise unique to solid-state imaging devices, and to capture plural different still images with a one-time mechanical shutter operation, and further to capture a plurality of still images having different focus positions. Thus, it is possible to perform imaging while moving the focal lens, recording each of images in the memory, and, after the imaging, select the still image having the optimum focus. In contrast, a configuration obtained by simply combining a mechanical shutter and a solid-state imaging device cannot provide the advantageous effects disclosed herein. In addition, the number of still images to be captured sequentially and the auto focus (AF) function can be freely set by means of an imaging person outside giving an instruction to the signal processing unit 20.

The imaging apparatus and the method of driving the same disclosed herein are non-limiting exemplary embodiments, and other embodiments are also possible. The herein disclosed subject matter covers other embodiments obtained by arbitrarily combing the elements of the above-described embodiments, various modifications conceived by a person skilled in the art and made in these exemplary embodiments without materially departing from the principles and spirit of the inventive concept, the scope of which is defined in the appended Claims and their equivalents, and various kinds of appliances mounting the imaging apparatus disclosed herein.

In the imaging apparatus according to Embodiment 1, the first exposure period and the second exposure period may be equal in length to each other. In addition, in the imaging apparatus according to Embodiment 2, the voltage values of the voltages which are applied to the photoelectric conversion film may be equal to each other in the first exposure period and the second exposure period. In this case, it is also possible to capture a plurality of still images, that is, perform sequential imaging with a one-time mechanical shutter.

Each of the structural elements in each of the above-described embodiments may be configured in the form of an exclusive hardware product, or may be realized by executing a software program suitable for the structural element. Each of the structural elements may be realized by means of a program executing unit, such as a CPU and a processor, reading and executing the software program recorded on a recording medium such as a hard disk or a semiconductor memory. Here, the software program for realizing the imaging apparatus according to each of the embodiments is a program described below.

The herein disclosed subject matter is to be considered descriptive and illustrative only, and the appended Claims are of a scope intended to cover and encompass not only the particular embodiment(s) disclosed, but also equivalent structures, methods, and/or uses.

### INDUSTRIAL APPLICABILITY

The imaging apparatus and method according to one or more exemplary embodiments disclosed herein make it possible to capture a plurality of still images with a one-time mechanical shutter operation, and are particularly applicable to video cameras, digital still cameras, camera modules for mobile appliances such as mobile phones, etc.

1. An imaging apparatus comprising:
a solid-state imaging device in which pixels are arranged in a matrix above a substrate, each pixel including (i) a photoelectric conversion unit which performs photoelectric conversion of incident light into signal charge and (ii) a reset unit which resets charge stored in the photoelectric conversion unit;
a mechanical shutter for causing all of the pixels to be shielded or exposed at a same time; and
a timing control unit configured to control timing for opening and closing the mechanical shutter, applying a voltage to the photoelectric conversion unit, and a reset by the reset unit,
wherein the timing control unit is configured to:
when a mode for monitoring an image is switched to a mode for capturing a still image, reset the charge stored in all of the pixels by closing the mechanical shutter and applying, to the photoelectric conversion unit, a disabling voltage for disabling movement of the charge generated by the photoelectric conversion unit; and
when a plurality of still images are to be captured sequentially:
(1) (i) start first exposure by opening the mechanical shutter and applying, to the photoelectric conversion unit, an enabling voltage for enabling movement of the charge generated by the photoelectric conversion unit, (ii) finish the first exposure by applying, to the photoelectric conversion unit, a disabling voltage for disabling movement of the charge generated by the photoelectric conversion unit, with the mechanical shutter open, (iii) obtain a first still image by reading pixel signals from the pixels, and (iv) cause the reset unit to reset the charge stored in all of the pixels; and
(2) (i) start second exposure by applying, to the photoelectric conversion unit, an enabling voltage for enabling movement of the signal charge generated by the photoelectric conversion unit, with the mechanical shutter open and (ii) finish the second exposure by applying, to the photoelectric conversion unit, a disabling voltage for disabling movement of the signal charge generated by the photoelectric conversion unit, with the mechanical shutter open, and (iii) obtain a second still image by reading pixel signals from the pixels.

2. The imaging apparatus according to claim 1,
wherein the first exposure is performed during a first exposure period, and the second exposure is performed during a second exposure period different in length from the first exposure period.

3. The imaging apparatus according to claim 1,
wherein the timing control unit is configured to obtain n still images each (i) comprising the still image and (ii) obtained through exposure in an exposure period of a different length, by performing sequential imaging n times with the mechanical shutter open, and generate m still images by combining the n still images, n being a natural number of 2 or larger, m being a natural number satisfying n≧m.

4. The imaging apparatus according to claim 1,
wherein the enabling voltage for enabling the movement of the charge generated by the photoelectric conversion unit applied to the photoelectric conversion unit when the first exposure is performed and the enabling voltage for enabling the movement of the charge generated by the photoelectric conversion unit applied to the photoelectric conversion unit when the second exposure is performed have different values.

5. The imaging apparatus according to claim 1,
wherein the timing control unit is configured to obtain n still images each (i) comprising the still image and (ii) obtained through exposure in an exposure period during which a voltage having a different value is applied to the photoelectric conversion unit, by performing sequential imaging n times with the mechanical shutter open, and generate m still images by combining the n still images, n being a natural number of 2 or larger, m being a natural number satisfying n≧m.

6. The imaging apparatus according to claim 4,
wherein one of the different values of the enabling voltage for enabling the movement of the charge generated by the photoelectric conversion unit and being applied to the photoelectric conversion unit when the first exposure is performed and the disabling voltage for disabling the movement of the charge generated by the photoelectric conversion unit and being applied to the photoelectric conversion unit when the second exposure is performed is a signal value indicating a black level of a video and to be output, from the pixels, as a total value of the pixel signals.

7. The imaging apparatus according to claim 6,
wherein the timing control unit is configured to perform signal processing on an image other than the black level image, based on the black level image.

8. The imaging apparatus according to claim 6,
wherein the timing control unit is configured to calculate, for each of the pixels, a value indicating a difference between data of the black level image and data of a reference image which is provided from outside, determine a pixel having a difference value exceeding a predetermined value to be a defective pixel, and correct a defect of image data in an image other than the black level image, the image data being of an image portion corresponding to the defective pixel.

9. The imaging apparatus according to claim 1, further comprising:
a focal lens; and
a memory for storing data of the pixel signals,
wherein the timing control unit is further configured to control a focal length of the focal lens, and
when the plurality of still images are to be captured sequentially,
the first still image and the second still image are obtained by changing the focal length of the focal lens, and data of the first still image and the second still image are stored in the memory.

10. A method of driving an imaging apparatus including: a solid-state imaging device in which pixels are arranged in a matrix above a substrate, each pixel including (i) a photoelectric conversion unit which performs photoelectric conversion of incident light into signal charge and (ii) a reset unit which resets charge stored in the photoelectric conversion unit; and a mechanical shutter for causing all of the pixels to be shielded or exposed at a same time, the method comprising:
a first reset step of resetting the charge stored in all of the pixels by closing the mechanical shutter and applying, to the photoelectric conversion unit, a disabling voltage for disabling movement of the charge generated by the photoelectric conversion unit;
a first exposure step of performing first exposure by opening the mechanical shutter and applying, to the photoelectric conversion unit, an enabling voltage for enabling movement of the charge generated by the photoelectric conversion unit, the first exposure step being performed after the first reset step;
a first reading step of (i) finishing the first exposure by applying, to the photoelectric conversion unit, a disabling voltage for disabling movement of the charge generated by the photoelectric conversion unit, and (ii) obtaining a first still image by reading pixel signals from the pixels, the first reading step being performed with the mechanical shutter open after the first exposure step;
a second reset step of causing the reset unit to reset the charge stored in all of the pixels while the disabling voltage for disabling movement of the charge generated by the photoelectric conversion unit is applied to the photoelectric conversion unit, the second reset step being performed with the mechanical shutter open after the first reading step;
a second exposure step of performing second exposure by applying, to the photoelectric conversion unit, an enabling voltage for enabling movement of the charge generated by the photoelectric conversion unit, the second exposure step being performed with the mechanical shutter open after the second reset step; and
a second reading step of (i) finishing the second exposure by applying, to the photoelectric conversion unit, a disabling voltage for disabling movement of the charge generated by the photoelectric conversion unit, and (ii) obtaining a second still image by reading pixel signals from the pixels, the second reading step being performed with the mechanical shutter open after the second exposure step.

11. The method of driving the imaging apparatus according to claim 10,
wherein, in the second exposure step, the second exposure is performed during a second exposure period different in length from a first exposure period during which the first exposure is performed.

12. The method of driving the imaging apparatus according to claim 10,
wherein in the second exposure step, the second exposure is performed by applying, to the photoelectric conversion unit, the enabling voltage different in value from the enabling voltage for enabling movement of the charge generated by the photoelectric conversion unit and applied to the photoelectric conversion unit when the first exposure is performed.

13. The method of driving the imaging apparatus according to claim 10,
wherein the first still image is obtained in the first exposure step, and the second still image is obtained in the second exposure step, by changing a focal length of a focal lens of the imaging apparatus between the first exposure step and the second exposure step, and
data of the first still image and the second still image are stored in a memory after the second reading step.
